(19) United States
(12) Patent Application Publication
(10) Pub. No.: US 2024/0323992 A1
(43) Pub. Date: Sep. 26, 2024

(54) RUNTIME ADJUSTMENT AND SEQUENTIAL CALIBRATION OF DISPLAY COMMUNICATION INTERFACE DRIVE STRENGTH TO IMPROVE WIRELESS NETWORK SIGNAL QUALITY

(71) Applicant: QUALCOMM Incorporated, San Diego, CA (US)

(72) Inventors: Nan ZHANG, Beijing (CN); Junzhi ZHAO, Shenzhen (CN); Yongjun XU, Beijing (CN)

(21) Appl. No.: 18/576,259

(22) PCT Filed: Aug. 23, 2021
(86) PCT No.: PCT/CN2021/114010

§ 371 Date: Jan. 3, 2024

(51) Int. Cl. H04W 72/541; H04B 17/318; H04L 12/40

(52) U.S. Cl. CPC H04W 72/541; H04B 17/328; H04L 12/40

(57) ABSTRACT

Systems, methods, and apparatus for controlling radio frequency (RF) interference at a mobile communication device are described. A data communication apparatus has a wireless transceiver configured to transmit and receive RF signals, a bus interface circuit coupled to a serial bus and configured for operation as a display serial interface (DSI), and a controller. The controller is configured to receive a measurement of a reference signal representative of RF signal quality at the mobile communication device, determine whether the measurement of the reference signal indicates that the RF signal quality is less than a minimum RF signal quality level, and reduce signal strength of a transmitter in the bus interface circuit when the RF signal quality falls below the minimum RF signal quality level.

### TECHNICAL FIELD

The present disclosure relates generally to serial communication over a serial bus in a wireless communication device and, more particularly, to suppression of electromagnetic interference originating in the serial bus.

### BACKGROUND

Mobile communication devices typically include a variety of components such as circuit boards, integrated circuit (IC) devices, application-specific integrated circuit (ASIC) devices and/or System-on-Chip (SoC) devices. The types of components may include processing circuits, user interface components, storage and other peripheral components that communicate through a serial bus. The serial bus may be operated in accordance with a standardized or proprietary protocol. In one example, a serial bus operated in accordance with an Inter-Integrated Circuit (I2C bus or FC). The I2C bus was developed to connect low-speed peripherals to a processor, where the I2C bus is configured as a multi-drop bus. A two-wire I2C bus includes a Serial Data Line (SDA) that carries a data signal, and a Serial Clock Line (SCL) that carries a clock signal.

A serial bus can be operated in accordance with a multi-master protocol and one or more devices may be a designated a bus master or controller for the serial bus in some transmissions and a slave or respondent device for other transmissions. In one example, Improved Inter-Integrated Circuit (I3C) protocols may be used to control operations on a serial bus. I3C protocols are defined by the Mobile Industry Processor Interface (MIPI) Alliance and derive certain implementation aspects from the I2C protocol. In another example, the Radio Frequency Front-End (RFFE) interface defined by the MIPI Alliance provides a communication interface for controlling various radio frequency (RF) front-end devices, including power amplifier (PA), low-noise amplifiers (LNAs), antenna tuners, filters, sensors, power management devices, switches, etc. These devices may be collocated in a single IC device or provided in multiple IC devices. In a mobile communication device, multiple antennas and radio transceivers may support multiple concurrent RF links.

Multiple standards are defined for interconnecting certain types of components in mobile communication devices. For example, there are multiple types of interfaces defined for communication between an application processor and display or camera components in a mobile communication device. Some components employ an interface that conforms to one or more standards or protocols specified by the MIPI Alliance, including protocols for a camera serial interface (CSI) and a display serial interface (DSI).

The MIPI Alliance CSI-2, DSI and DSI-2 standards define a wired interface that can be deployed within or between integrated circuit (IC) devices and/or System-on-Chip (SoC) devices. The wired interface may be provided to couple a camera and application processor (CSI), or an application processor and display (DSI). The low-level physical-layer (PHY) interface in each of these applications can be MIPI C-PHY or MIPI D-PHY. High-speed modes and low-power modes of communication are defined for MIPI C-PHY and MIPI D-PHY. The MIPI C-PHY high-speed mode uses a low-voltage multiphase signal transmitted in different phases on a 3-wire link. The MIPI D-PHY high-speed mode uses a plurality of 2-wire lanes to carry low-voltage differential signals. The low-power mode of MIPI C-PHY and MIPI D-PHY provides lower rates than the high-speed mode and transmits signals at higher voltages. The high-speed signals are undetectable by receivers configured for low-power operation.

As device technology improves, demands for higher data rate over serial buses and radio frequency (RF) interfaces continue to increase and increased data rates may involve high-frequency signals that produce increased levels of electromagnetic interference. There is a continuous need to improve interfaces to take advantage of technology improvements while mitigating or suppressing ill effects of higher frequency signals.

### SUMMARY

Certain aspects of the disclosure relate to systems, apparatus, methods and techniques by which a wireless communication device can mitigate or suppress electromagnetic interference generated by a serial data communication link when the interference affects a wireless radio frequency signal. In some examples, the interference can be mitigated by reducing the power or signal strength of signals transmitted over the wires of the serial bus.

In various aspects of the disclosure, a data communication apparatus has a wireless transceiver configured to transmit and receive radio frequency (RF) signals, a bus interface circuit coupled to a serial bus and configured for operation as a display serial interface (DSI), and a controller. The controller is configured to receive a measurement of a reference signal representative of RF signal quality at the mobile communication device, determine whether the measurement of the reference signal indicates that the RF signal quality is less than a minimum RF signal quality level, and reduce signal strength of a transmitter in the bus interface circuit when the RF signal quality falls below the minimum RF signal quality level.

In various aspects of the disclosure, a method for controlling RF interference at a mobile communication device includes receiving a measurement of a reference signal representative of RF signal quality at the mobile communication device, determining whether the measurement of the reference signal indicates that the RF signal quality is less than a minimum RF signal quality level, and reducing signal strength of a transmitter coupled to a serial bus provided in the mobile communication device when the RF signal quality falls below the minimum RF signal quality level, the serial bus configured to operate in accordance with a DSI protocol.

In various aspects of the disclosure, a mobile communication apparatus has means for determining whether a measurement of a reference signal representative of RF signal quality at the mobile communication device indicates that the RF signal quality is less than a minimum RF signal quality level, and means for modifying signal strength of a transmitter coupled to a serial bus provided in the mobile communication device, configured to reduce the signal strength of the transmitter when the RF signal quality falls below the minimum RF signal quality level, the serial bus configured to operate in accordance with a DSI protocol.

In various aspects of the disclosure, a processor-readable storage medium stores or maintains code for receiving a measurement of a reference signal representative of RF signal quality at the mobile communication device, determining whether the measurement of the reference signal indicates that the RF signal quality is less than a minimum RF signal quality level, and reducing signal strength of a transmitter coupled to a serial bus provided in the mobile communication device when the RF signal quality falls below the minimum RF signal quality level, the serial bus configured to operate in accordance with a DSI protocol.

In some aspects, a controller may be configured to determine that a transmission error occurred in a transmission over the serial bus, and increase the signal strength of the transmitter in the bus interface circuit in response to the transmission error. A list of calibrated signal strengths may be maintained by the mobile communication device. The controller may be further configured to remove an entry in the list of calibrated signal strengths when the transmission error occurs while the signal strength of the transmitter is defined by the entry in the list of calibrated signal strengths. For example, the entry may be removed from the list of calibrated signal strengths after repeated transmission errors have occurred while the signal strength of the transmitter is defined by the entry in the list of calibrated signal strengths.

In some aspects, the controller is further configured to maintain a list of calibrated signal strengths at the mobile communication device. Each entry in the list of calibrated signal strengths may indicate a signal strength level that has been verified as enabling the transmitter to transmit data over the serial bus without error. The list of calibrated signal strengths is configured during manufacture or assembly of the mobile communication device.

In some aspects, a bus interface circuit responsive to the controller is configured to change the signal strength of the transmitter while the serial bus is idle, and calibrate timing of signals transmitted over the serial bus after changing the signal strength of the transmitter. The bus interface circuit may be further configured to use a bus calibration procedure defined by C-PHY protocols when restarting the serial bus. The bus interface circuit may be further configured to use a bus calibration procedure defined by D-PHY protocols when restarting the serial bus.

In one aspect, the reference signal comprises a reference signal received power (RSRP) signal transmitted in a fifth-generation new radio (5G-NR) wireless network.

### BRIEF DESCRIPTION OF THE DRAWINGS

FIG. 1 illustrates an apparatus employing a data link between IC devices and that is selectively operated according to a standard or proprietary protocol.

FIG. 2 illustrates a system architecture for an apparatus employing a data link between IC devices.

FIG. 3 illustrates a device configuration for coupling various radio frequency front-end devices using multiple RFFE buses.

FIG. 4 illustrates an example of a C-PHY interface.

FIG. 5 illustrates an example of a D-PHY interface.

FIG. 6 illustrates examples of apparatus that may be adapted according to certain aspects disclosed herein.

FIG. 7 illustrates transitions between signaling modes in an example of a D-PHY interface.

FIG. 8 illustrates transitions between signaling modes in a C-PHY interface adapted in accordance with certain aspects disclosed herein.

FIG. 9 is a flowchart that illustrates an example of a process used to monitor RF signal quality in order to determine when DSI signal strength is to be reduced to mitigate the effects of electromagnetic interference on RF radio operations in accordance with certain aspects disclosed herein.

FIG. 10 is a flowchart that illustrates an example of a process used to reconfigure a DSI PHY to increase or decrease with DSI signal strength in accordance with certain aspects disclosed herein.

FIG. 11 illustrates one example of an apparatus employing a processing circuit that may be adapted according to certain aspects disclosed herein.

FIG. 12 is a flowchart that illustrates a method that may be performed by a slave device that is coupled to a serial bus in accordance with certain aspects disclosed herein.

FIG. 13 illustrates an example of a hardware implementation for a communication apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple devices, SoCs or other IC devices often employ multiple data communications link to connect processors with modems and other peripherals. The data communication links may be operated in accordance with industry or proprietary standards or protocols associated with certain functions or types of devices. In the example of display panels, display subsystems, and display drivers, communication standards and protocols defined by the MIPI Alliance are frequently used. The Display Serial Interface (DSI®), for example, provides C-PHY and D-PHY standards and protocols used to define, configure and control a high-speed serial interface between a host processor and a display module. Other standards and protocols may be provided for ancillary uses, including control and management buses implemented using I2C or I3C protocols.

In mobile communication handsets, user equipment and other devices, interfaces operated in accordance with DSI specifications are frequently among the top sources of RF interference with regards to the RF interface in the devices. The data rates required to support high resolution displays or imaging devices can result in high-frequency electromagnetic interference (EMI) that can affect RF signals. For example, high data rate DSI signaling can involve transmission of signals over wires at frequencies similar to the frequencies of RF signals. Such EMI can occur notwithstanding the expectation that the differential signaling used in C-PHY interfaces can suppress electromagnetic emissions.

According to certain aspects of this disclosure, power levels in DSI interfaces may be modified to mitigate EMI identified in RF signals. Multiple power levels may be pre-calibrated for C-PHY or D-PHY transmission in a target device. Each of the pre-calibrated power levels can be determined during design, manufacture or system integration to ensure that the DSI signal integrity requirements are satisfied. RF interference at a mobile communication device can be controlled by receiving a measurement of a reference signal representative of RF signal quality at the mobile communication device, determining whether the measurement of the reference signal indicates that the RF signal quality is less than a minimum RF signal quality level, and reducing signal strength of a transmitter coupled to a display serial interface (DSI) bus provided in the mobile communication device when the RF signal quality falls below the minimum RF signal quality level.

Examples of Apparatus that Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

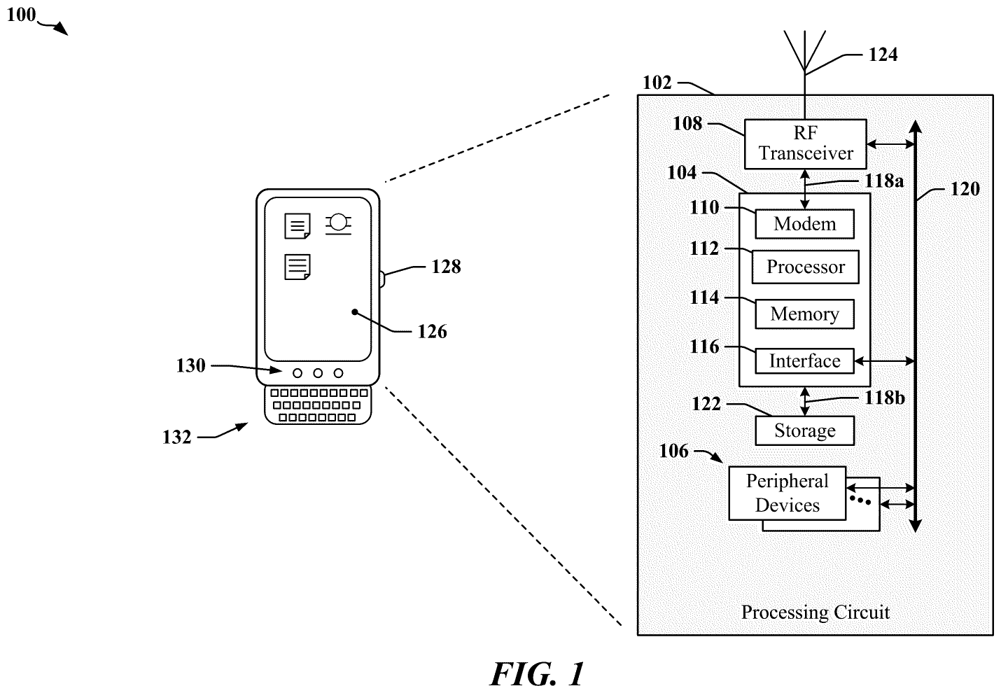

FIG. 1 illustrates an example of an apparatus 100 that employs a data communication bus. The apparatus 100 may include an SoC, or a processing circuit 102 having multiple circuits or devices 104, 106 and/or 108, which may be implemented in one or more ASICs. In one example, the apparatus 100 may operate as a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 or an external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with standards-defined communication specifications or protocols. The processing circuit 102 may include or control a power management function that configures and manages the operation of the apparatus 100.

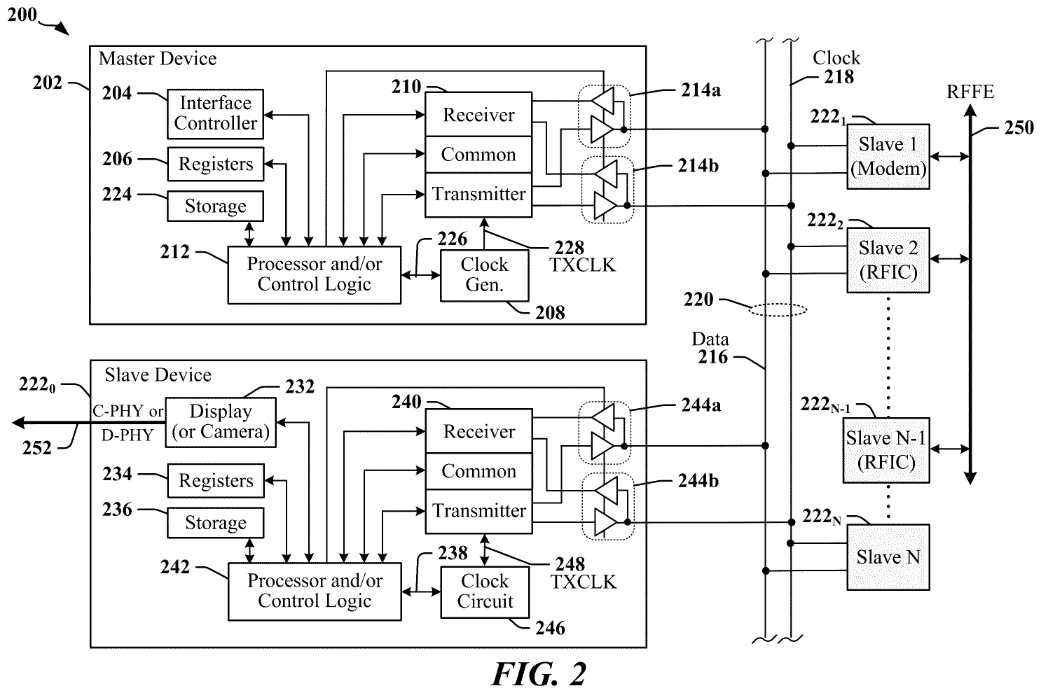

FIG. 2 illustrates certain aspects of an apparatus 200 that includes multiple devices 202, and 222₀-222_{N} coupled to a serial bus 220. The devices 202 and 222₀-222_{N} may be implemented in one or more semiconductor IC devices, such as an application processor, SoC or ASIC. In various implementations the devices 202 and 222₀-222_{N} may include, support or operate as a modem, a signal processing device, a display driver, a camera, a user interface, a sensor, a sensor controller, a media player, a transceiver, and/or other such components or devices. In some examples, one or more of the slave devices 222₀-222_{N} may be used to control, manage or monitor a sensor device. Communication between devices 202 and 222₀-222_{N} over the serial bus 220 is controlled by a bus master device 202. Certain types of bus can support multiple bus master devices 202.

In one example, a master device 202 may include an interface controller 204 that manages access to the serial bus, configures dynamic addresses for slave devices 222₀-222_{N} and/or generates a clock signal 228 to be transmitted on a clock line 218 of the serial bus 220. The master device 202 may include configuration registers 206 or other storage 224, and other control logic 212 configured to handle protocols and/or higher-level functions. The control logic 212 may include a processing circuit having a processing device such as a state machine, sequencer, signal processor or general-purpose processor. The master device 202 includes a transceiver 210 and line drivers/receivers 214a and 214b. The transceiver 210 may include receiver, transmitter and common circuits, where the common circuits may include timing, logic and storage circuits and/or devices. In one example, the transmitter encodes and transmits data based on timing in the clock signal 228 provided by a clock generation circuit 208. Other timing clock signals 226 may be used by the control logic 212 and other functions, circuits or modules.

At least one device 222₀-222_{N} may be configured to operate as a slave device on the serial bus 220 and may include circuits and modules that support a display, an image sensor, and/or circuits and modules that control and communicate with one or more sensors that measure environmental conditions. In one example, a slave device 222o configured to operate as a display or imaging interface device may communicate with a display or camera through a DSI interface controller 232 that includes circuits and modules to support, control or communicate with the display or camera. The slave device 222o may include configuration registers 234 or other storage 236, control logic 242, a transceiver 240 and line drivers/receivers 244a and 244b. The control logic 242 may include a processing circuit having a processing device such as a state machine, sequencer, signal processor or general-purpose processor. The transceiver 240 may include receiver, transmitter and common circuits, where the common circuits may include timing, logic and storage circuits and/or devices. In one example, the transmitter encodes and transmits data based on timing in a clock signal 248 provided by clock generation and/or recovery circuits 246. The clock signal 248 may be derived from a signal received from the clock line 218. Other timing clock signals 238 may be used by the control logic 242 and other functions, circuits or modules.

The serial bus 220 may be operated in accordance with RFFE, I2C, I3C or other protocol. In some instances, two or more devices 202, 222₀-222_{N} may be configured to operate as a bus master device on the serial bus 220. In some instances, the apparatus 200 includes multiple serial buses 220, 250, 252 that couple two or more of the devices 202, 222₀-222_{N} or one of the devices 202, 222₀-222_{N} and a peripheral device such as a display, imaging device or a Radio-Frequency IC (RFIC). In the illustrated example, certain slave devices 222₁, 222₂, 222_{N-1} are coupled to a serial bus 250 that is operated in accordance with RFFE protocols, and two of these slave devices 222₁, 222₂ are also coupled to the primary serial bus 220 operated in accordance with another protocol. In the illustrated example, one slave device 222₀ is configured to operate as a display controller that communicates with a display device over a serial bus 252 operated in accordance with a C-PHY protocol (or D-PHY protocol).

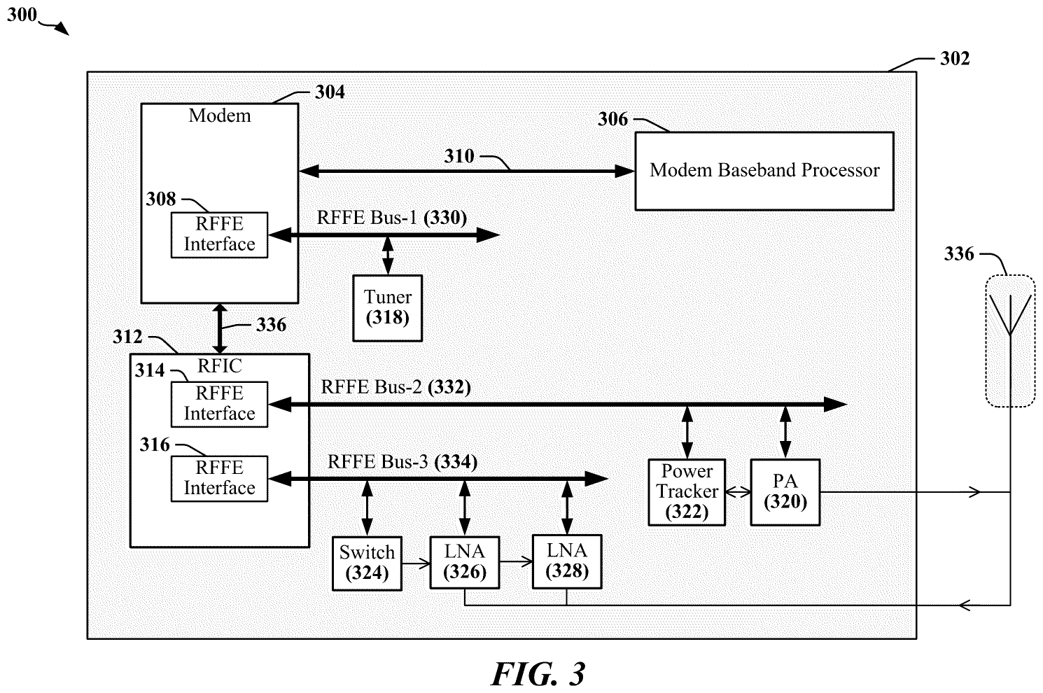

FIG. 3 illustrates certain aspects of an apparatus 300 that includes multiple RFFE buses 330, 332, 334 coupled to various RF front-end devices 318, 320, 322, 324, 326, 328. A modem 302 includes an RFFE interface 308 that couples the modem 302 to a first RFFE bus 330. The modem 302 may communicate with a baseband processor 306 and an RFIC 312 through one or more communication links 310, 336. The illustrated apparatus 300 may be embodied in one or more of a mobile communication device, a mobile telephone, a mobile computing system, a mobile telephone, a notebook computer, a tablet computing device, a drone, an appliance, a sensor, a media player, a gaming device, a wearable computing and/or communications device, an appliance, or the like.

In various examples, the apparatus 300 may be implemented with one or more baseband processors 306, modems 304, RFICs 312, multiple communications links 310, 336, multiple RFFE buses 330, 332, 334 and/or other types of buses. The apparatus 300 may include other processors, circuits, modules and may be configured for various operations and/or different functionalities. In the example illustrated in FIG. 3, the modem 304 is coupled to an RF tuner 318 through its RFFE interface 308 and the first RFFE bus 330. The RFIC 312 may include one or more RFFE interfaces 314, 316, controllers, state machines and/or processors that can configure and control certain aspects of the RF front-end. The RFIC 312 may communicate with a PA 320 and a power tracking module 322 through a first of its RFFE interfaces 314 and the second RFFE bus 330. The RFIC 312 may communicate with a switch 324 and one or more LNAs 326, 328.

In certain aspects of this disclosure, systems and apparatus may employ multi-phase data encoding and decoding interface methods for communicating between IC devices. A multi-phase encoder may drive a plurality of conductors (i.e., M conductors). The M conductors typically include three or more conductors, and each conductor may be referred to as a wire, although the M conductors may include conductive traces on a circuit board or within a conductive layer of a semiconductor IC device. In one example, the MIPI Alliance-defined “C-PHY” physical layer interface technology may be used to connect camera or display to an application processor. The C-PHY interface employs three-phase symbol encoding to transmit data symbols on 3-wire lanes, or “trios” where each trio includes an embedded clock.

The M conductors may be divided into a plurality of transmission groups, each group encoding a portion of a block of data to be transmitted. An N-phase encoding scheme is defined in which bits of data are encoded in phase transitions and polarity changes on the M conductors. Decoding does not rely on independent conductors or pairs of conductors and timing information can be derived directly from phase and/or polarity transitions in the M conductors. N-Phase polarity data transfer can be applied to any physical signaling interface, including electrical, optical and radio frequency (RF) interfaces.

In the C-PHY example, a three-phase encoding scheme for a three-wire system may define three phase states and two polarities, providing 6 states and 5 possible transitions from each state. Deterministic voltage and/or current changes may be detected and decoded to extract data from the three wires.

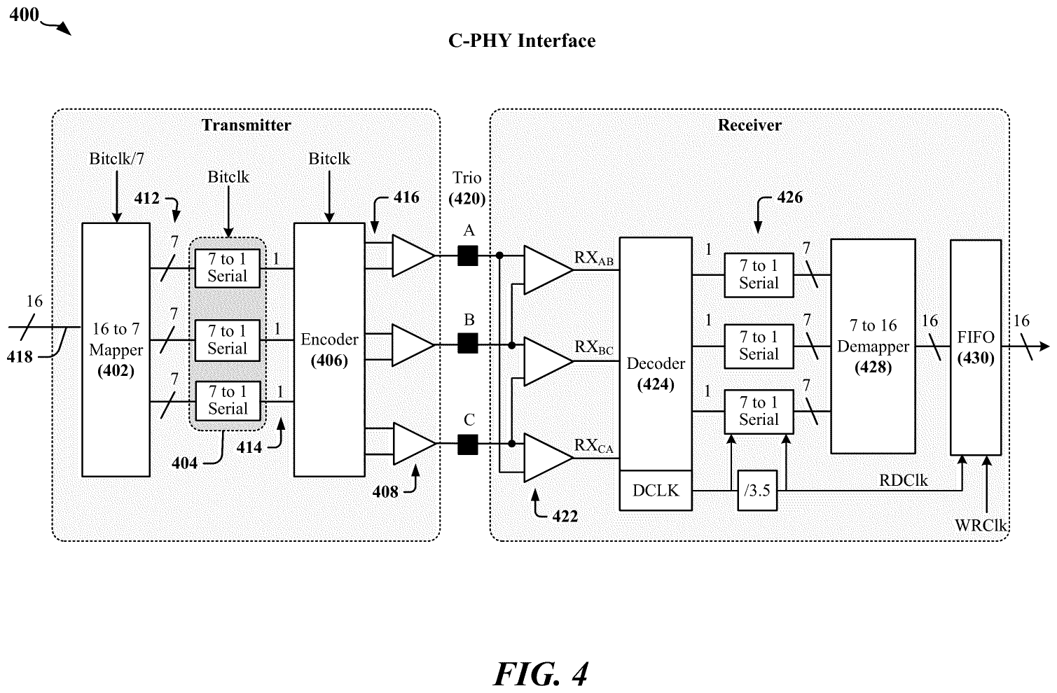

FIG. 4 illustrates a C-PHY interface 400 that may be used to implement certain aspects of the serial bus 252 depicted in FIG. 2. The illustrated example may relate to a three-wire link configured to carry three-phase polarity encoded data in accordance with DSI protocols. The use of 3-phase polarity encoding provides for high-speed data transfer and may consume half or less of the power of other interfaces because fewer than 3 drivers are active at any time in a C-PHY link. The C-PHY interface uses 3-phase polarity encoding to encode multiple bits per symbol transition on the three-wire link. In one example, a combination of three-phase encoding and polarity encoding may be used to support a wide video graphics array (WVGA), 80 frames per second liquid crystal display driver IC without a frame buffer, delivering pixel data for display refresh at 810 Mbps over three or more wires.

In the depicted C-PHY interface 400, three-phase polarity encoding is used to control signaling state of connectors, wires, traces and other interconnects that provide a 3-wire bus (the trio 420). Each wire in the trio 420 may be undriven, driven positive, or driven negative in any symbol transmission interval. In some instances, an undriven signal wire of the trio 420 may be in a high-impedance state. In some instances, an undriven signal wire of the trio 420 may be driven or pulled to a voltage level that lies substantially halfway between the positive and negative voltage levels provided on driven signal wires. In some instances, an undriven signal wire of the trio 420 may have no current flowing through it. Drivers 408 coupled to the signal wires of the trio 420 are controlled such that only one wire of the trio 420 is in each of three states (denoted as +1, −1, or 0) in each symbol interval.

In one example, drivers 408 may include unit-level current-mode drivers. In another example, drivers 408 may drive opposite polarity voltages on two signals transmitted on two signal wires of the trio 420 while the third signal wire is at high impedance and/or pulled to ground. For each transmitted symbol interval, at least one signal is in the undriven (0) state, while one signal is driven to the positive (+1 state) and one signal is driven to the negative (−1 state), such that the sum of current flowing to the receiver is always zero. For each symbol, the state of at least one signal wire of the trio 420 is changed from the symbol transmitted in the preceding transmission interval.

In the C-PHY interface 400, a mapper 402 may receive a 16-bit input data word 418, and the mapper 402 may map the input data word 418 to 7 symbols 412 for transmitting sequentially over the signal wires of the trio 420. An M-wire, N-phase encoder 406 configured for three-wire, three-phase encoding receives the 7 symbols 412 produced by the mapper one input symbol 414 at a time and computes the state of each signal wire of the trio 420 for each symbol interval, based on the immediately preceding state of the signal wires of the trio 420. The 7 symbols 412 may be serialized using parallel-to-serial converters 404, for example. The encoder 406 selects the states of the signal wires of the trio 420 based on the input symbol 414 and the previous states of signal wires of the trio 420.

The use of three-wire, three-phase encoding permits several bits to be encoded in a plurality of symbols where the bits per symbol is not an integer. In the example of a three-wire, three-phase system, there are 3 available combinations of 2 wires, which may be driven simultaneously, and 2 possible combinations of polarity on the simultaneously driven pair of wires, yielding 6 possible states. Since each transition occurs from a current state, 5 of the 6 states are available at every transition. With 5 states, log₂(5)≅2.32 bits may be encoded per symbol transition. Accordingly, a mapper may accept a 16-bit word and convert it to 7 symbols because 7 symbols carrying 2.32 bits per symbol can encode 16.24 bits. In other words, a combination of seven symbols that encodes five states has 5⁷ (78,125) permutations. Accordingly, the 7 symbols may be used to encode the 2¹⁶ (65,536) permutations of 16 bits.

The C-PHY interface 400 includes a receiver that includes comparators 422 and a decoder 424 that are configured to provide a digital representation of the state of each of three signal wires of the trio 420, as well as the change in the state of the three signal wires compared to the state transmitted in the previous symbol period. Seven consecutive states are assembled by serial-to-parallel convertors 426 and used to produce a set of 7 symbols to be processed by a demapper 428 to obtain 16 bits of data that may be buffered in a first-in-first-out (FIFO) storage device 530, which may be implemented using registers, for example.

According to certain aspects disclosed herein, systems and apparatus may employ some combination of differential and single-ended encoding for communicating between IC devices. In one example, the MIPI Alliance-defined “D-PHY” physical layer interface technology may be used to connect camera and display devices to an application processor. The D-PHY interface can switch between a differential (High-Speed) mode and a single-ended low power (LP) mode in real time as needed to facilitate the transfer of large amounts of data or to conserve power and prolong battery life. The D-PHY interface is capable of operating in simplex or duplex configuration with single data lane or multiple data lanes with a unidirectional (Master to Slave) clock lane.

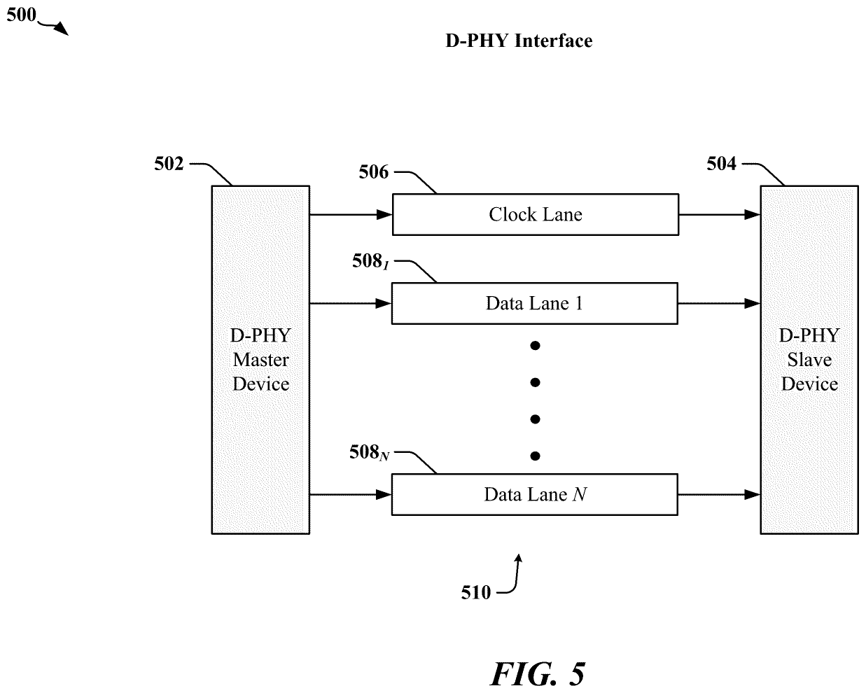

FIG. 5 illustrates a generalized D-PHY configuration 500 that includes a master device 502 and a slave device 504. The master device 502 generates clock signals that control transmissions on the wires 510. A clock signal is transmitted on a clock lane 506 and data is transmitted in one or more data lanes 508₁-508_{N}. The number of data lanes 508₁-508_{N} that are provided or active in a device may be dynamically configured based on application needs, volumes of data to be transferred and power conservation needs.

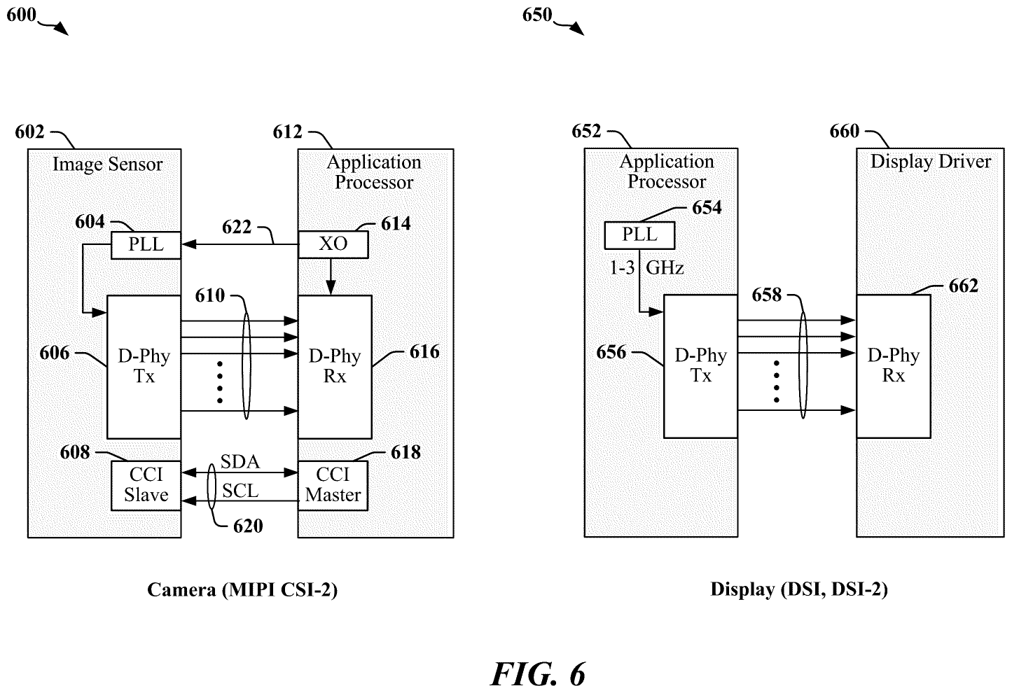

FIG. 6 illustrates certain interface configurations associated with a camera subsystem 600 and a display subsystem 650 that may be deployed within a mobile communication device, for example. The camera subsystem 600 may include a CSI-2 defined communication link between an image sensor 602 and an application processor 612. The communication link may include a high-data rate data transfer link 610 used by the image sensor 602 to transmit image data to the application processor 612 using a transmitter 606. The high-data rate data transfer link 610 may be configured and operated according to D-PHY or C-PHY protocols. The application processor 612 may include a crystal oscillator (XO) 614 or other clock source to generate a clock signal 622 that controls the operation of the transmitter 606. The clock signal 622 may be processed by a phase-locked loop (PLL) 604 in the image sensor 602. In some instances, the clock signal 622 may also be used by the D-PHY or C-PHY receiver 616 in the application processor 612. The communication link may include a Camera Control Interface (CCI), which is similar in nature to the Inter-Integrated Circuit (I2C) interface. The CCI bus may include Serial Clock (SCL) line that carries a clock signal and a Serial Data (SDA) line that carries data. The CCI link 620 may be bidirectional and may operate at a lower data rate than the high-data rate data transfer link 610. The CCI link 620 may be used by the application processor 612 to transmit control and data information to the image sensor 602 and to receive control and configuration information from the image sensor 602. The application processor 612 may include a CCI bus master 618 and the image sensor 602 may include a CCI slave 608.

The display subsystem 650 may include a unidirectional data link 658 that can be configured and operated according to D-PHY or C-PHY protocols. In the application processor 652, a clock source such as the PLL 654 may be used to generate a clock signal for controlling transmissions on the data link 658. At the display driver 660, a D-PHY or C-PHY receiver 662 may extract embedded clock information from sequences of symbols transmitted on the data link, or from a clock lane provided in the data link 658.

Certain aspects disclosed herein relate to systems, apparatus and methods that support a broad range of interface protocols, and that can operate using different physical media. As shown in FIG. 6, for example, the camera subsystem 600 and/or display subsystem 650 may communicate high data rate information using D-PHY or C-PHY protocols and, in some configurations, may communicate using a reverse channel (e.g., the CCI link 620) for configuration of an image sensor 602 or other device. In some instances, a low power mode of operation may be defined for links that use either D-PHY or C-PHY protocols.

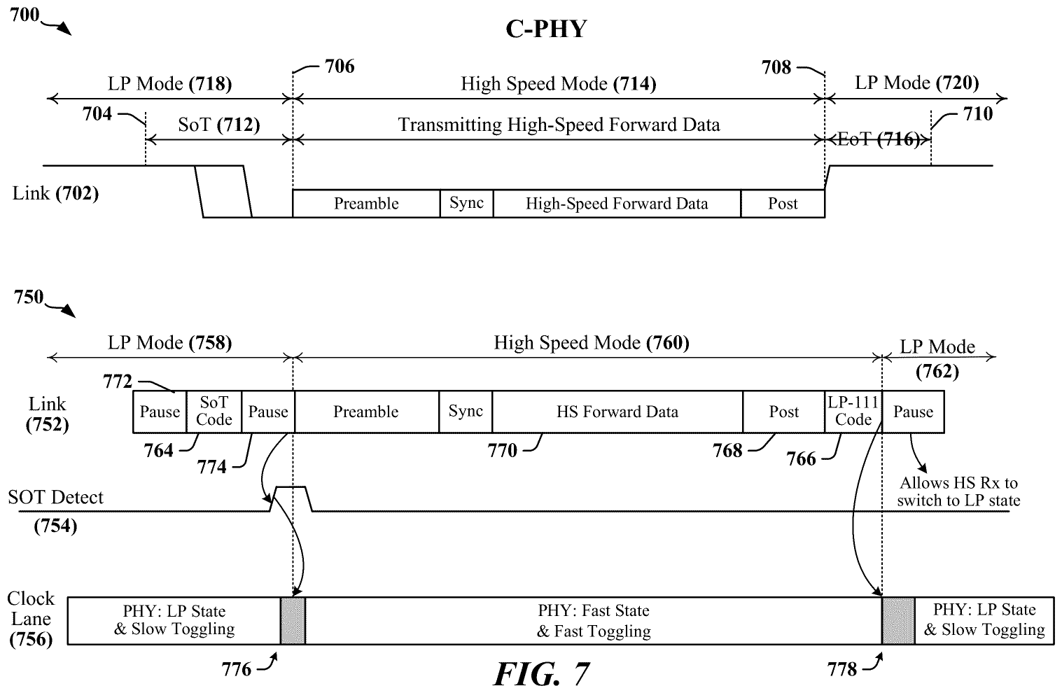

FIG. 7 illustrates transitions between communication modes of a C-PHY interface for a conventional mode of operation 700 and transitions between communication modes in an advanced low-power (ALP) mode of operation 750 in a C-PHY interface. In the conventional mode of operation 700 the C-PHY interface is initially configured for a low-power mode of operation 718. Commencing at a first time 704, the SoT sequence 712 is transmitted to switch the C-PHY interface to a high-speed mode of operation 714. Commencing at a second time 708, an EoT sequence 716 is transmitted to return the C-PHY interface to a low-power mode of operation 720. A receiver may determine that the return the C-PHY interface to a low-power mode of operation 720 is desired based on signaling received at the higher voltage levels of the low-power mode.

According to certain aspects disclosed herein, a C-PHY interface adapted to support an ALP mode of operation 750, transitions between high-speed and low-power modes in response to code words 764, 766 and a Post sequence 768 defined by C-PHY protocols. In the ALP mode of operation 750, low-voltage differential signaling is used for high-speed mode 760 and for low-power mode 758, 762. Accordingly, transitions between high-speed mode 760 and for low-power mode 758, 762 are not detectable using the voltage level sensors employed in some conventional C-PHY interfaces. Code words 764 and 766 and the Post sequence 768 used in ALP mode of operation 750 may be transmitted to convey corresponding mode transitions and/or other events. In the C-PHY example, a Post sequence 768 is already provided at the end of a high-speed data transmission to provide a reliable notification of the end of a high-speed burst to the receiver. In C-PHY protocols, the Post sequence 768 is provided at the end of high-speed (HS) Forward Data 770 and the PHY knows that the high-speed transmission is ended by detecting the Post sequence 768. The Post sequence 768 includes a series of unmapped code words (e.g., a sequence in which all symbols have a value of “4”). A start of transmission (SoT) code word 764 may be transmitted to initiate the high-speed mode 760. The SoT code word 764 may include a sequence of code words. In one example, the SoT code word 764 may be defined as the sequence {LP-111, LP-001, LP-000}. The SoT code word 764 may be preceded by a first pause 772 and followed by a second pause 774.

In a C-PHY interface, symbol timing is embedded in the waveform, and there is no need to manage the transmission clock signal during transitions between high-speed mode 760 and low-power modes 758, 762. According to certain aspects disclosed herein, all of the LP Escape Mode Code Words in a C-PHY interface (see Table 1 below) can use in whole or in part, unique C-PHY sequences of seven or more symbols that are not created by the C-PHY data mapping function. This allows the C-PHY receiver to reliably detect all of the code words without having to rely as much on the specific state of transmission. While in the high-speed transmission mode, the C-PHY receiver can always recover to the correct power state.

As illustrated in FIG. 7, an untransmitted clock lane at 756, which may be representative of clock generation circuits or clock extraction circuits, begins transitioning from low-power mode 758 to high-speed mode 760 during the pause 774 that occurs after the SoT code word 764 has been transmitted on the on the link 752. The transition from low-power mode 758 to high-speed mode 760 may include pausing state low-power state toggling and enabling high-speed mode terminations. Transition from high-speed mode 760 to a next low-power mode 762 may be commenced after the LP-111 code has been transmitted on the on the link 752. The transition from high-speed mode 760 to a next low-power mode 762 may include pausing high-speed state toggling and enabling high-speed mode terminations.

In some instances, signals may be toggled only when a code needs to be transmitted when the PHY is in a low-power state. In some instances, continuous clock mode may be implemented where one lane toggles on a regular basis during low-power state. Continuous clock mode version may support certain implementations where some link activity is required or desired, including links that include optical media and/or links that operate in accordance with MIPI Alliance DSI-2 specifications. According to certain aspects, a master device may be configured to select a clock rate used in low-power and/or other modes.

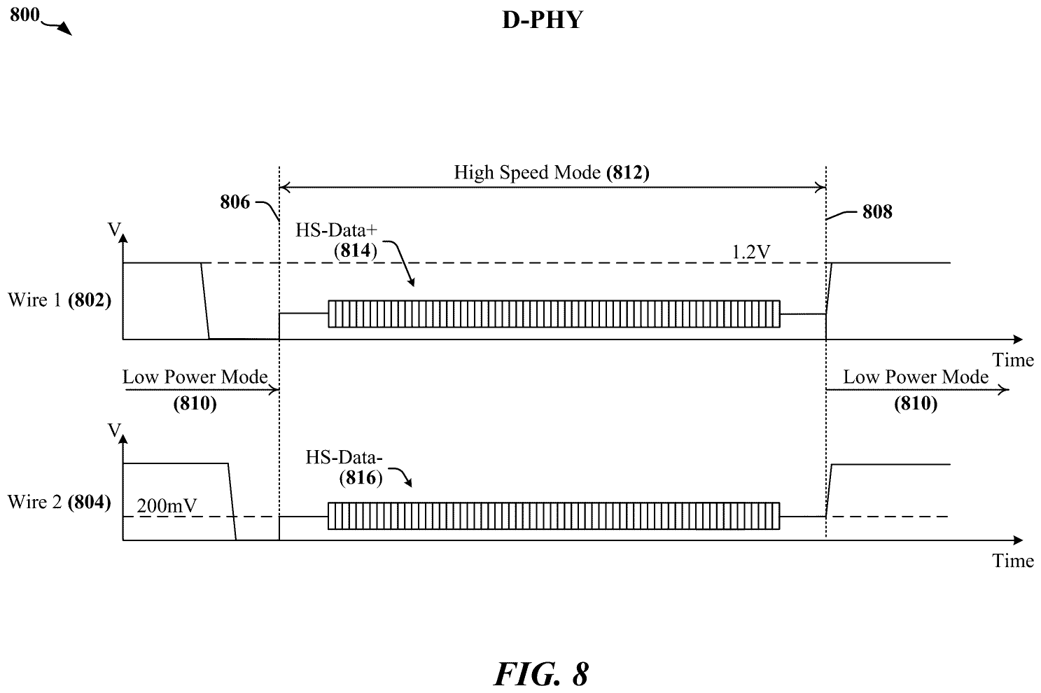

FIG. 8 is a graphical representation 800 of waveforms illustrating transitions between communication modes using an example of a D-PHY interface. The example relates to two wires 802, 804 of a clock or data lane of a communication link. The D-PHY interface may be configured to operate in a low-power mode 810 and/or a high-speed mode 812. In the low-power mode 810, a first wire carries data signals at a relatively low data rate and with a voltage level swing of approximately 1.2 volts. In the high-speed mode 812, the first wire 802 and second wire 804 carry a low-voltage differential signal that may have a data rate that is orders of magnitude faster than the data rate of the low-power mode 810. For example, the low-power mode 810 may support data rates up to 10 megabits per second (Mbps) while the high-speed mode 812 may support data rates that lie between 80 Mbps and 4.5 gigabits per second (Gbps). The positive version of the differential signal may be carried on the first wire 802, while the negative version is carried on the second wire 804, in the high-speed mode 812. The differential signal may have a relatively low amplitude voltage swing, which in one example may be approximately 200 millivolts (mV). Receivers in conventional C-PHY and D-PHY interfaces can use voltage level detectors to switch between high-speed and low-power modes of operation.

A mobile communication handset typically employs multiple serial buses to interconnect devices that perform the various functions of the handset. There is a potential for EMI generation by serial buses including serial buses used to couple components of RF transmitters and serial buses used to couple display or imaging devices.

In mobile communication handsets and other devices, interfaces operated in accordance with DSI specifications defined by the MIPI Alliance are frequently among the top sources of RF interference. Constituent frequencies in signals transmitted over serial buses operated in accordance with DSI specifications have increased as display and imaging resolution and color depth have increased. The data rates required to support high resolution displays or imaging devices can result in high frequency emissions by serial buses that impinge on the frequencies of RF signals transmitted by the device. For example, display-related signals transmitted in accordance with C-PHY and D-PHY protocols can cause electromagnetic emissions at frequencies that interfere with RF signals of similar frequency and may further interfere with signals transmitted over RFFE or other serial buses coupled to RF transceivers. Such interference can occur notwithstanding the expectation that the differential signaling used in C-PHY interfaces can suppress electromagnetic emissions.

The deployment of fifth generation, new radio (5G-NR) capable mobile communication devices may be capable of operating in frequency range 2 (FR2) that includes frequency bands that are greater than 6 GHz. The probability of interference between serial buses carrying display-related signals and RF-related circuits and buses is increased significantly in 5G-NR devices operating in FR2. When FR2 is used, frequency bands from 700 MHz to greater than 20 GHz are available to the mobile communication device and RF signals may be more easily affected by display-related signals.

Displays with higher resolution, greater bit depths and flexible and increased frames per second (FPS) rates may necessitate that C-PHY or D-PHY interfaces may be clocked at frequencies be dynamically accommodate dynamically switched FPS and display resolutions. In certain examples, C-PHY or D-PHY interfaces may be clocked using clock signal that have a frequency of between 100 MHz and 1.8G Hz and interference with the RF signals associated with the RF modem in the mobile communication device can seriously affect 5G-NR wireless signal quality, reliability and mobility.

Certain techniques are used to mitigate EMI caused by high data rate transmissions over serial buses, including the use of spread-spectrum clocking (SSC), differential signaling and dynamic clock rate change. SSC has been shown to be ineffective as implemented in conventional systems. C-PHY interfaces use differential signaling and can nevertheless generate EMI that affects RF circuits. Certain DSI interfaces employ dynamic clock rate change to avoid the use of clock signal frequencies that fall within bands of frequencies within the band of frequencies used by an RF circuit. In one example of a mobile communication device that transmits using the FR1 range, the clock frequency used on the D-PHY interface may be dynamically modified to avoid the frequency bands employed by the RF circuits. For instance, a mobile communication device transmitting in a band centered on 700 MHz may switch to a band centered on 1.8 GHz and a D-PHY interface may clock change. For instance, a mobile communication device may include a wireless transmitter that is tuned to an RF band in the range of 700 M Hz to 1.8 GHz and may further include a DSI D-PHY that can modify its transmission clock between 800 HZ and 850 HZ when needed to avoid or mitigate RF interference.

Conventional solutions generally have limited or no effectiveness in mobile communication devices that transmit using the 5G-NR range. 5G-NR provides much larger RF bandwidths than the RF bandwidths that are available in older radio access technologies. Subbands of the RF bandwidths assigned for the use of individual mobile communication devices or individual modems in the mobile communication devices are also much wider. For example, a 5G-NR subband may extend from 20 MHz to 100 MHz and the magnitude of frequency change required to implement dynamic clock rate change may be impractical. In some instances, DSI clock changes of up to 20 MHz may be required in a device operating at the FR1 range, while DSI clock changes of up to 100 MHz may be required in a device operating at the FR2 range. The conventional DSI clock change margin is limited and the possibility of finding DSI bit clock range for jumping in FR2 operation is nearly impossible. Moreover, current organic light-emitting diode (OLED) display panels support features and functions that rely on synchronization with the DSI bit clock. Dynamic DSI bit clock change can cause loss of synchronization and failure of corresponding functions and features. Implementing larger dynamic clock rate changes may require the sacrifice of many critical display panel functions or features.

According to certain aspects of this disclosure, power levels in DSI interfaces may be modified to mitigate EMI identified in RF signals. A transmitter in a C-PHY or D-PHY interface provided in accordance with certain aspects of this disclosure can control power levels in the outputs of it line drivers, including in high-speed mode. In some examples, power level can be selected to mitigate against EMI generated by transmissions over the serial bus. Multiple power levels may be pre-calibrated for C-PHY or D-PHY transmission in a target device. Each of the pre-calibrated power levels can be determined during design, manufacture or system integration to ensure that the DSI signal integrity requirements are satisfied. In one example, pre-calibrated power levels for a D-PHY interface may be defined as the set of differential voltage levels: {220 mV, 200 mV, 160 mV, 150 mV}. The pre-calibrated power levels for a C-PHY or D-PHY interface may be defined as the set of voltage levels, current levels or some combination of voltage, current and/or power. In some examples, the set of voltage and/or current levels may be generated or modified dynamically using calibration sequences defined by C-PHY or D-PHY protocols.

In some examples, a processing circuit in the mobile communication device may configure a power level for a DSI interface (C-PHY or D-PHY) by selecting a differential voltage level from the set of differential voltage levels. The selection of differential voltage level may be based on measurements of received RF transmissions, including one or more reference signals wirelessly transmitted by a base station, access point or other wireless network entity. Reference signals may be transmitted in a known symbol, where the symbol is defined as a combination of frequency and time resources or elements, and the reference signals may be transmitted with a known transmission power and encoding. The mobile communication device may be configured to measure a reference signal received power (RSRP), one or more reference signal received quality (RSRQ), or other suitable reference signals that are indicative of signal-to-interference and noise ratio (SINR) and other indicators of RF signal quality at the mobile communication device. The measurements may be obtained from radio front end circuits such as the power tracker 322, LNAs 326, 328 (see FIG. 3), automatic gain control circuits, filters and other circuits.

The mobile communication device may be configured with values of one or more measurement thresholds that can be used to characterize RF signal quality. The measurement threshold values may be compared to measurements indicative of RF signal quality obtained by the mobile communication device. Certain measurement thresholds may define transition points between acceptable and unacceptable RF signal quality. In one example, a first measurement threshold may be used to compare RSRP measurements and may indicate unacceptable RF signal quality when the RSRP measurement falls below the value of the first measurement threshold. In another example, a second measurement threshold may be used to compare RSRP measurements and may indicate when RF signal quality is sufficiently good to enable a corresponding RF transmitter to reduce transmitter power levels when the RSRP measurement rises above the value of the second measurement threshold. In another example, a third measurement threshold may be used to compare one or more reference signal measurements indicative of SINR and may indicate unacceptable RF signal quality when the reference signal measurement falls below the value of the third measurement threshold.

Measurement thresholds may be configured by an application resident on the mobile communication device, by a base station or other wireless network access point and/or by one or more RFFE circuits. In one example, measurement thresholds may be configured by a coexistence manager that operates to minimize RF interference between two transmitters in the same mobile communication device. The measurement thresholds may correspond to signal quality thresholds. The signal quality thresholds may be configured for a wireless network, the mobile communication device or for management purposes at a base station or other wireless network access point.

In some examples, the processing circuit in the mobile communication device may select a lower DSI drive strength (lower voltage) when a reduction in measured RSRP level indicates reduced RF signal quality. The reduced DSI drive strength may be expected to mitigate the interference in the measured RF signal. Reductions in the DSI drive strength can affect DSI signal integrity. In some instances, DSI signal integrity may be degraded to an extent that the DSI signal fails to meet minimum signal quality requirements. DSI signal integrity for each member of the set of differential voltage levels may be tested and confirmed during calibration. The calibration process may be used to tune the set of differential voltage levels to include or identify differential voltage levels that enable the C-PHY or D-PHY interface to meet minimum signal quality requirements. In some examples, a receiving end uses a display driver integrated circuit (DDIC) to monitor or measure signals received from the C-PHY or D-PHY serial bus. The DDIC may include circuits that perform MIPI-defined data integrity checks and low-level checks that determine whether the received signals conform or are compliant with specifications or protocols governing operation of the serial bus.

An entry in a set of differential voltage or current levels may be deleted when DSI signal fails to meet minimum signal quality requirements when transmission strength is configured in accordance with the entry. In one example, the entry may be deleted after one or more DSI signal errors are reported when the corresponding DSI strength adjustment has been applied. In some instances, the one or more DSI signal errors may occur after an entry has been validated or has been applied for some period of time without issue. For example, an entry in the set of differential voltage or current levels may be removed from the set of differential voltage or current levels after the occurrence of changes in process, voltage or temperature (PVT) in an operating mobile communication device give rise to DSI signal errors. In other examples, the entry in the set of differential voltage or current levels may be marked as disabled or ineligible for selection at certain PVT corners after the occurrence of DSI signal errors associated with changes in PVT. When an entry corresponding to a currently configured DSI signal strength is removed or disabled from selection, the mobile communication device may fall back to a previous signal drive strength value.

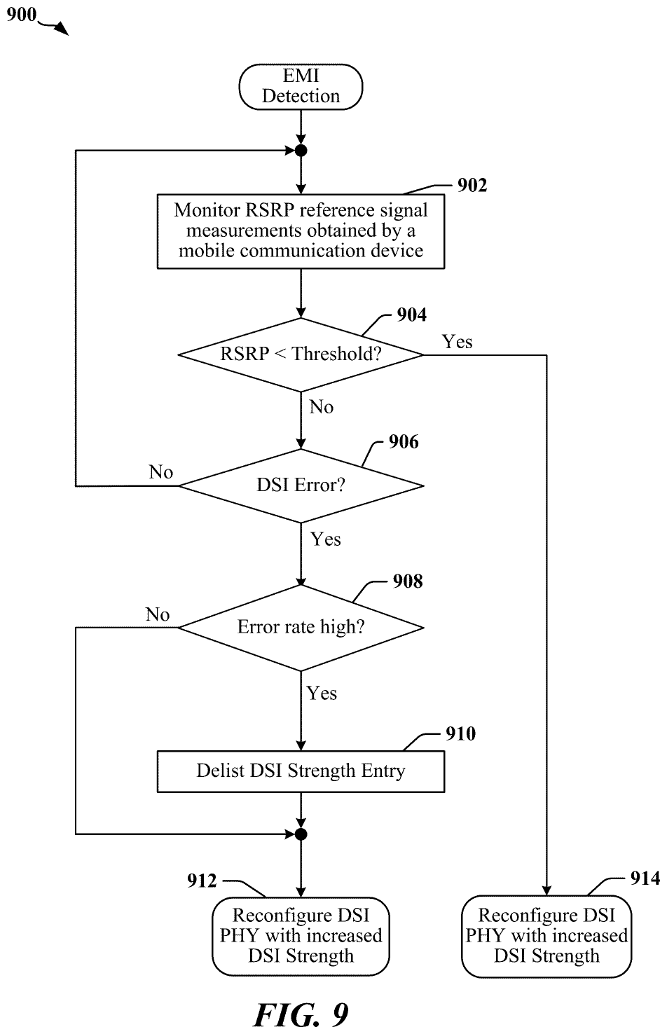

FIG. 9 is a flowchart 900 that illustrates an example of a process used to monitor RF signal quality in order to determine when DSI signal strength is to be reduced to mitigate the effects of EMI on RF radio operations in accordance with certain aspects disclosed herein. The process may be executed by a processing circuit in a wireless communication device. At block 902, the processing circuit may monitor one or more reference signals received by the wireless communication device. In the illustrated example, at least RSRP is measured and evaluated for determination of received RF signal quality. The measurements may be obtained from radio front end circuits such as the power tracker 322, LNAs 326, 328 (see FIG. 3), automatic gain control circuits, filters and other circuits. At block 904, the processing circuit may determine whether RSRP has dropped below a threshold value. When the RSRP falls below the threshold value, received RF signal quality may be considered less than acceptable and the process may continue at block 914. At block 914, the processing circuit may reconfigure the DSI PHY with reduced DSI signal strength. When the RSRP remains above the threshold value, received RF signal quality can be considered acceptable and the process may continue at block 906.

At block 906, the processing circuit may check for DSI signal errors. DSI signal errors may be indicated by the display panel. In one example, the DSI signal errors are communicated through a lower data rate control channel. When no new DSI signal errors have been reported, the processing circuit may continue to monitor the reference signal at blocks 902 and 904 (and reports of DSI signal errors at block 906). When a new DSI signal error is detected at block 906 the process proceeds to block 908.

At block 908, the processing circuit may determine if the detected DSI signal error is one of many reported errors. The processing circuit may calculate a time-average of DSI signal errors or a rate of occurrence of the DSI signal errors. In some examples, each detection of a new DSI signal error is logged with a timestamp that enables the rate or time-average to be calculated. When, for example, the rate of occurrence of DSI errors does not exceed a preconfigured threshold value, then the processing circuit may continue to reconfigure the DSI PHY with increased DSI signal strength at block 912. When the rate of occurrence of DSI errors exceeds the preconfigured threshold value, then the process may continue at block 910 where the current DSI strength entry is blocked or removed from a list of available, tested signal strengths, The list may be referred to as a calibration list or a whitelist. The process continues at block 912, where the processing circuit reconfigures the DSI PHY to increase signal strength.

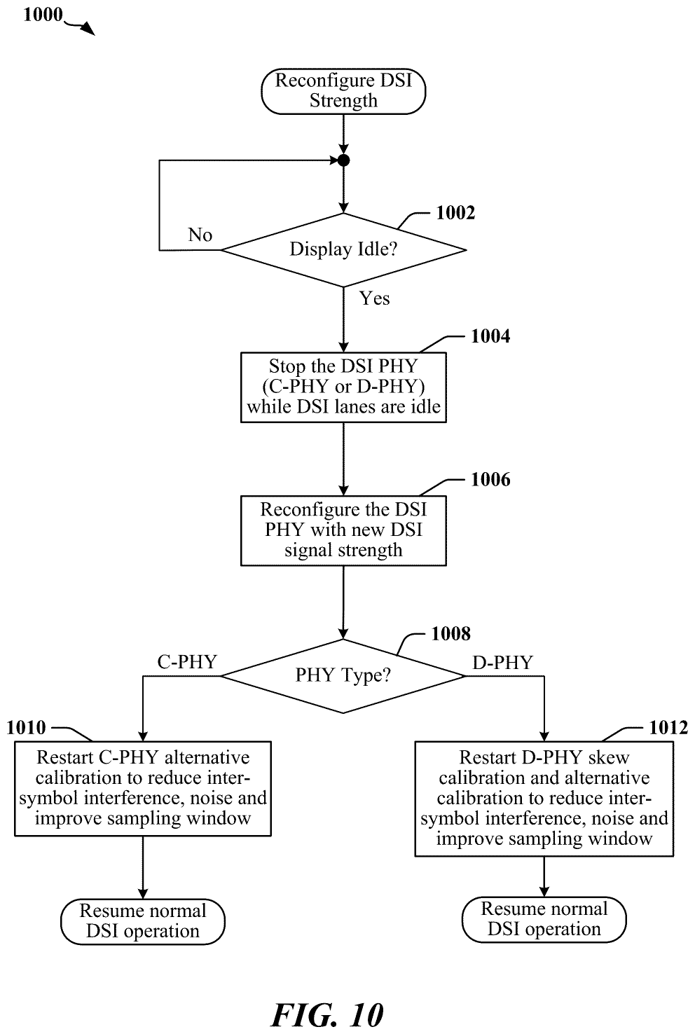

FIG. 10 is a flowchart 1000 that illustrates an example of a process that can be used to reconfigure a DSI PHY coupled to a serial bus to increase or decrease with DSI signal strength in accordance with certain aspects disclosed herein. The process may be performed by a processing circuit in a wireless communication device. The processing circuit may wait for a display subsystem to enter an idle state at block 1002. In one example, the idle state is an operating state in which the display is not refreshed. In one example, the display is refreshed at a lower refresh rate in the idle state. The lower refresh rate may correspond to 30 frames per second (i.e., 30 Hz) or lower. The reduced frame rate or no refresh state can provide a time window sufficient to perform a DSI drive strength adjustment. The process proceeds at block 1004 when the display is determined to be idle.

At block 1004, the processing circuit may stop or suspend DSI PHY operations. In some examples, DSI PHY operations are stopped or suspended when the lanes of the DSI interface are idle. The lanes of the DSI PHY may be idled during vertical blanking intervals, when refresh is suspended or when the DSI PHY has entered an idle time after high-speed transmission of a frame that terminated in command mode.

At block 1004, the processing circuit may reconfigure the DSI PHY using a new or updated DSI drive strength value. The DSI PHY may be reconfigured to increase or decrease DSI drive strength. In one example, a DISI PHY may reconfigure its DSI PHY using values maintained in configuration registers or other storage, where a reconfiguration command includes an index to the desired register or storage location. Reconfiguring the DSI PHY may include reconfiguring a transceiver and one or more line drivers/receivers and/or. In some instances, the line drivers may be capable of multiple modes of operation and multiple power levels. For example, the power level for a line driver operating in high level mode may be configured by modifying or setting bias currents or voltages for one or more transistors in an output stage of the line driver. The DSI PHY may be restarted after configuration. The process proceeds according to PHY type, which may be determined at block 1008.

At block 1008, the restart procedure for the DSI PHY may be selected based on PHY type. When the DSI PHY is operated as C-PHY, the process continues at block 1010 with a C-PHY alternative bus calibration procedure used to reduce inter symbol inference and noise, resulting in improved sampling intervals between transitions between consecutive symbols. When the DSI PHY is operated as D-PHY, the process continues at block 1012 with D-PHY skew calibration and alternative bus calibration procedures used to reduce inter symbol inference and noise, resulting in improved sampling intervals between transitions between clock intervals. Normal DSI operations are resumed after the appropriate restart procedure for the DSI PHY restart procedure has been completed. In certain examples, the timing of signals transmitted over one or more wires of the serial bus may be calibrated at the resumption of DSI operations. Alternative bus calibration and skew calibration may involve transmitting known sequences of data or symbols over the serial bus defined by C-PHY or D-PHY protocols such that the receiver and/or transmitter can adjust timing of clock signals to ensure that the signals on the serial bus are sampled when stable and without missing symbols or data bits. For example, a known sequences of symbols may be transmitted in one or more preambles.

### Examples of Processing Circuits and Methods

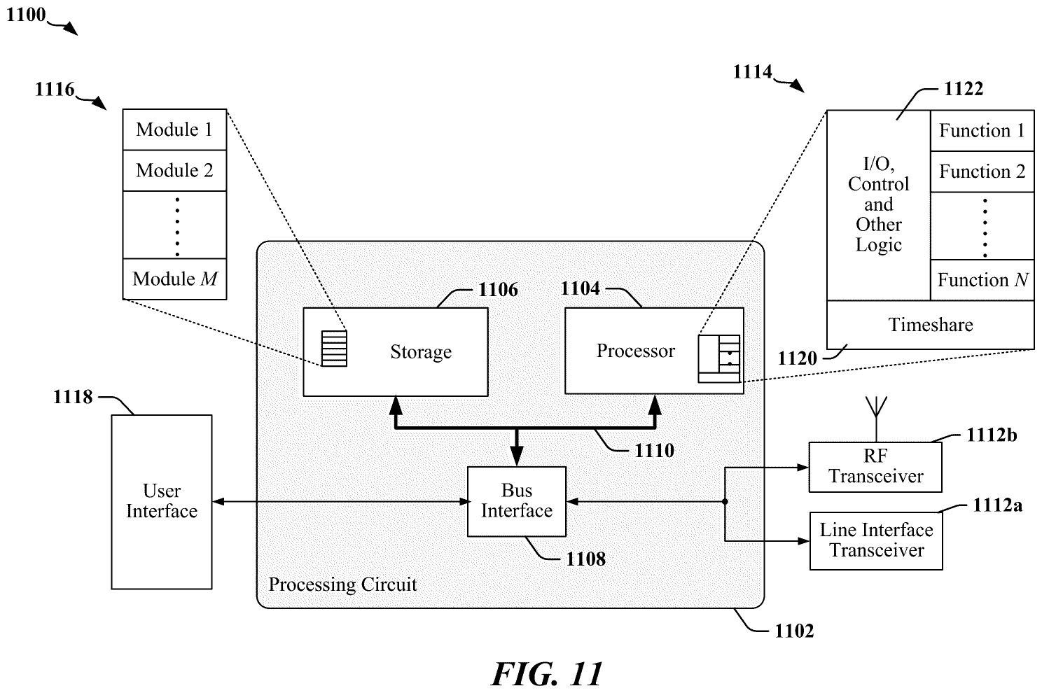

FIG. 11 is a diagram illustrating an example of a hardware implementation for an apparatus 1100. In some examples, the apparatus 1100 may perform one or more functions disclosed herein. In accordance with various aspects of the disclosure, an element, or any portion of an element, or any combination of elements as disclosed herein may be implemented using a processing circuit 1102. The processing circuit 1102 may include one or more processors 1104 that are controlled by some combination of hardware and software modules. Examples of processors 1104 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1104 may include specialized processors that perform specific functions, and that may be configured, augmented or controlled by one of the software modules 1116. The one or more processors 1104 may be configured through a combination of software modules 1116 loaded during initialization, and further configured by loading or unloading one or more software modules 1116 during operation.

In the illustrated example, the processing circuit 1102 may be implemented with a bus architecture, represented generally by the bus 1110. The bus 1110 may include any number of interconnecting buses and bridges depending on the specific application of the processing circuit 1102 and the overall design constraints. The bus 1110 links together various circuits including the one or more processors 1104, and storage 1106. Storage 1106 may include memory devices and mass storage devices, and may be referred to herein as computer-readable media and/or processor-readable media. The bus 1110 may also link various other circuits such as timing sources, timers, peripherals, voltage regulators, and power management circuits. A bus interface 1108 may provide an interface between the bus 1110 and one or more transceivers 1112a, 1112b. A transceiver 1112a, 1112b may be provided for each networking technology supported by the processing circuit. In some instances, multiple networking technologies may share some or all of the circuitry or processing modules found in a transceiver 1112a, 1112b. Each transceiver 1112a, 1112b provides a means for communicating with various other apparatus over a transmission medium. In one example, a transceiver 1112a may be used to couple the apparatus 1100 to a multi-wire bus. In another example, a transceiver 1112b may be used to connect the apparatus 1100 to a radio access network. Depending upon the nature of the apparatus 1100, a user interface 1118 (e.g., keypad, display, speaker, microphone, joystick) may also be provided, and may be communicatively coupled to the bus 1110 directly or through the bus interface 1108.

A processor 1104 may be responsible for managing the bus 1110 and for general processing that may include the execution of software stored in a computer-readable medium that may include the storage 1106. In this respect, the processing circuit 1102, including the processor 1104, may be used to implement any of the methods, functions and techniques disclosed herein. The storage 1106 may be used for storing data that is manipulated by the processor 1104 when executing software, and the software may be configured to implement certain methods disclosed herein.

One or more processors 1104 in the processing circuit 1102 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1106 or in an external computer-readable medium. The external computer-readable medium and/or storage 1106 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1106 may also include, by way of example, a carrier wave, a transmission line, and any other suitable medium for transmitting software and/or instructions that may be accessed and read by a computer. Computer-readable medium and/or the storage 1106 may reside in the processing circuit 1102, in the processor 1104, external to the processing circuit 1102, or be distributed across multiple entities including the processing circuit 1102. The computer-readable medium and/or storage 1106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1106 may maintain software maintained and/or organized in loadable code segments, modules, applications, programs, etc., which may be referred to herein as software modules 1116. Each of the software modules 1116 may include instructions and data that, when installed or loaded on the processing circuit 1102 and executed by the one or more processors 1104, contribute to a run-time image 1114 that controls the operation of the one or more processors 1104. When executed, certain instructions may cause the processing circuit 1102 to perform functions in accordance with certain methods, algorithms and processes described herein.

Some of the software modules 1116 may be loaded during initialization of the processing circuit 1102, and these software modules 1116 may configure the processing circuit 1102 to enable performance of the various functions disclosed herein. For example, some software modules 1116 may configure internal devices and/or logic circuits 1122 of the processor 1104, and may manage access to external devices such as a transceiver 1112a, 1112b, the bus interface 1108, the user interface 1118, timers, mathematical coprocessors, and so on. The software modules 1116 may include a control program and/or an operating system that interacts with interrupt handlers and device drivers, and that controls access to various resources provided by the processing circuit 1102. The resources may include memory, processing time, access to a transceiver 1112a, 1112b, the user interface 1118, and so on.

One or more processors 1104 of the processing circuit 1102 may be multifunctional, whereby some of the software modules 1116 are loaded and configured to perform different functions or different instances of the same function. The one or more processors 1104 may additionally be adapted to manage background tasks initiated in response to inputs from the user interface 1118, the transceiver 1112a, 1112b, and device drivers, for example. To support the performance of multiple functions, the one or more processors 1104 may be configured to provide a multitasking environment, whereby each of a plurality of functions is implemented as a set of tasks serviced by the one or more processors 1104 as needed or desired. In one example, the multitasking environment may be implemented using a timesharing program 1120 that passes control of a processor 1104 between different tasks, whereby each task returns control of the one or more processors 1104 to the timesharing program 1120 upon completion of any outstanding operations and/or in response to an input such as an interrupt. When a task has control of the one or more processors 1104, the processing circuit is effectively specialized for the purposes addressed by the function associated with the controlling task. The timesharing program 1120 may include an operating system, a main loop that transfers control on a round-robin basis, a function that allocates control of the one or more processors 1104 in accordance with a prioritization of the functions, and/or an interrupt driven main loop that responds to external events by providing control of the one or more processors 1104 to a handling function.

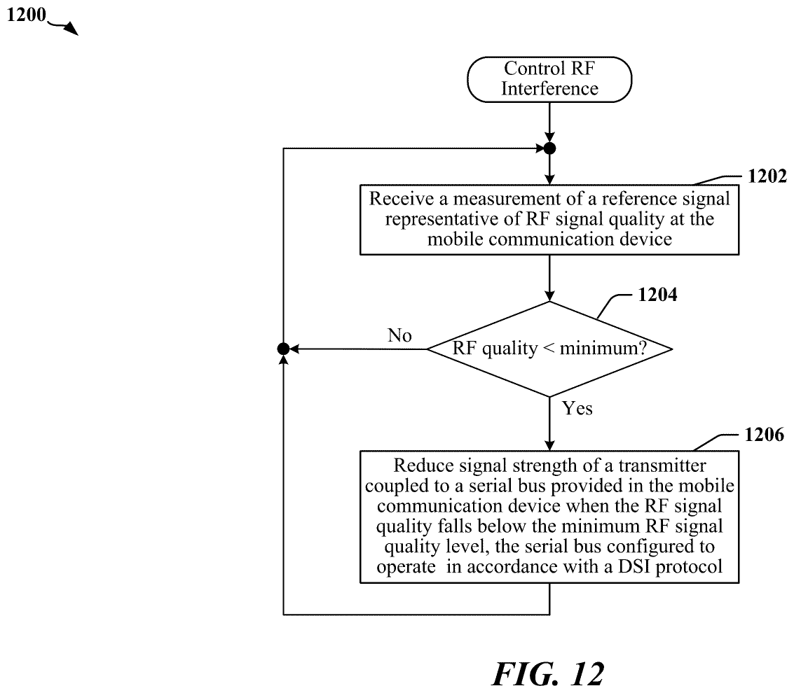

FIG. 12 is a flowchart 1200 of a method for controlling RF interference at a mobile communication device. In one example, the mobile communication device includes a serial bus operated in accordance with C-PHY or D-PHY protocols. The mobile communication device may include an RF transceiver coupled to an RFFE, and the RF transceiver can be configured to wirelessly transmit and receive RF signals over a radio access network that includes a base station that can configure and control RF transmissions between the base station and multiple wireless communication devices or between pairs of wireless communication devices.

The method may be performed using a controller or other processor in the mobile communication device. The controller may configure serial bus transmitters and may receive measurements of RF signals from the RF transceiver or other components associated with the RFFE. In the illustrated method, at block 1202, the controller may receive a measurement of a reference signal representative of RF signal quality at the mobile communication device. The measurement may be made an amplifier, automatic gain control circuit, filter, digital signal processor or other type of circuit device in the RFFE or coupled to the RFFE. In one example, measurements may be obtained from circuits such as the power tracker 322 and LNAs 326, 328 illustrated in FIG. 3. At block 1204, the controller may determine whether the measurement of the reference signal indicates that the RF signal quality is less than a minimum RF signal quality level. The minimum quality level may be defined by a base station or may be based on standards or protocols governing the radio access network. If the RF signal quality is not indicated to be less than the minimum RF signal quality level, then the controller may continue monitoring the reference signal at block 1202. When the RF signal quality is indicated to be less than the minimum RF signal quality level, then at block 1206 the controller may reduce signal strength of a transmitter coupled to a serial bus provided in the mobile communication device when the RF signal quality falls below the minimum RF signal quality level, the serial bus configured to operate in accordance with a DSI protocol.

In certain examples, the controller may determine that a transmission error occurred in a transmission over the serial bus, and may increase the signal strength of the transmitter coupled to the serial bus in response to the transmission error. A list of calibrated signal strengths may be maintained by the mobile communication device. The controller may remove an entry in the list of calibrated signal strengths when the transmission error occurs while the signal strength of the transmitter is defined by the entry in the list of calibrated signal strengths. In some instances, the entry is removed from the list of calibrated signal strengths after repeated transmission errors have occurred while the signal strength of the transmitter is defined by the entry in the list of calibrated signal strengths.

In some examples, the controller may change or cause to be changed the signal strength of the transmitter while the serial bus is idle. The timing of signals transmitted over the serial bus may be calibrated after the controller has caused the signal strength of the transmitter to be changed. Calibrating timing of signals transmitted over the serial bus may include using a bus calibration procedure defined by C-PHY protocols when restarting the serial bus. Calibrating timing of signals transmitted over the serial bus may include using a bus calibration procedure defined by D-PHY protocols when restarting the serial bus.

In one example, the reference signal is a RSRP signal transmitted in a 5G-NR radio access network or other wireless network. In some examples, a list of calibrated signal strengths is maintained at the mobile communication device. Each entry in the list of calibrated signal strengths may indicate a signal strength level that has been verified as enabling the transmitter to transmit data over the serial bus without error. The list of calibrated signal strengths is configured during manufacture or assembly of the mobile communication device.

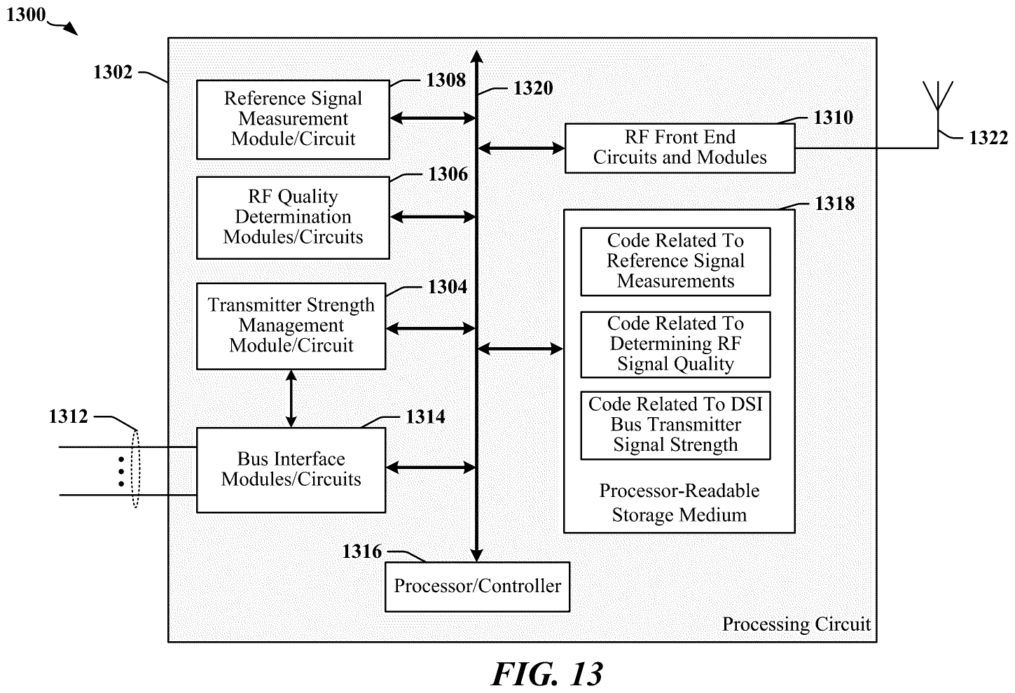

FIG. 13 is a diagram illustrating an example of a hardware implementation for an apparatus 1300 employing a processing circuit 1302. The processing circuit typically has one or more microprocessors, microcontrollers, digital signal processors, sequencers and/or state machines, represented generally by the processors 1316. The processing circuit 1302 may be implemented with a bus architecture, represented generally by the bus 1320. The bus 1320 may include any number of interconnecting buses and bridges depending on the specific application of the processing circuit 1302 and the overall design constraints. The bus 1320 links together various circuits including one or more processors 1316, the modules or circuits 1304, 1306, 1308 and 1310 and the processor-readable storage medium 1318. A bus interface circuit and/or module 1314 may be provided to support communications over a serial bus 1312 and RFFE circuits and modules 1310 that support wireless communication with the radio access network. The RFFE circuits and modules 1310 may include switches, amplifiers, filters and power trackers 322, LNAs 326, 328 (see FIG. 3), automatic gain control circuits, filters and other circuits. The RFFE circuits and modules 1310 may include or be coupled to one or more antennas 1322. The bus 1320 may also link various other circuits such as timing sources, peripherals, voltage regulators, and power management circuits, which are well known in the art, and therefore, will not be described any further.

The processors 1316 may be responsible for general processing, including the execution of software, code and/or instructions stored on the processor-readable storage medium 1318. The processor-readable storage medium 1318 may include a non-transitory storage medium. The software, when executed by the processors 1316, causes the processing circuit 1302 to perform the various functions described supra for any particular apparatus. The processor-readable storage medium may be used for storing data that is manipulated by the processors 1316 when executing software. The processing circuit 1302 further includes at least one of the modules 1304, 1306 and 1308. The modules 1304, 1306 and 1308 may be software modules running in the processors 1316, resident/stored in the processor-readable storage medium 1318, one or more hardware modules coupled to the processors 1316, or some combination thereof. The modules 1304, 1306 and 1308 may include microcontroller instructions, state machine configuration parameters, or some combination thereof.

In one configuration, the apparatus 1300 includes modules and/or circuits 1304 adapted to manage, configure and/or control drive strength of one or more transmitters in the bus interface circuit and/or module 1314, and modules and/or circuits 1306 adapted to determine quality of RF signals detected or measured at the antennas 1322. The apparatus 1300 may include modules and/or circuits 1308 adapted to manage or obtain measurements of reference signals received at the antennas 1322.

In one example, the apparatus 1300 is configured to operate as a mobile communication device that has a wireless transceiver configured to transmit and receive RF signals through one or more antennas 1322, a bus interface circuit and/or module 1314 configured to couple the apparatus 1300 to a serial bus, and a controller or other processor. The bus interface circuit and/or module 1314 may be configured for DSI operations. The controller may be configured to receive a measurement of a reference signal representative of RF signal quality at the mobile communication device, determine whether the measurement of the reference signal indicates that the RF signal quality is less than a minimum RF signal quality level, and reduce signal strength of a transmitter in the bus interface circuit when the RF signal quality falls below the minimum RF signal quality level.

In certain examples, the controller is further configured to determine that a transmission error occurred in a transmission over the serial bus, and increase the signal strength of the transmitter in the bus interface circuit in response to the transmission error. A list of calibrated signal strengths is maintained by the mobile communication device. The controller may be further configured to remove an entry in the list of calibrated signal strengths when the transmission error occurs while the signal strength of the transmitter is defined by the entry in the list of calibrated signal strengths. The entry may be removed from the list of calibrated signal strengths after repeated transmission errors have occurred while the signal strength of the transmitter is defined by the entry in the list of calibrated signal strengths.

In some examples, the bus interface circuit is responsive to the controller and configured to change the signal strength of the transmitter while the serial bus is idle, and to calibrate timing of signals transmitted over the serial bus after changing the signal strength of the transmitter. The bus interface circuit is further configured to use a bus calibration procedure defined by C-PHY protocols when restarting the serial bus. The bus interface circuit may be further configured to use a bus calibration procedure defined by D-PHY protocols when restarting the serial bus.

In one example, the reference signal is a RSRP signal transmitted in a 5G-NR wireless network. The controller may be further configured to maintain a list of calibrated signal strengths at the mobile communication device. Each entry in the list of calibrated signal strengths indicates a signal strength level that has been verified as enabling the transmitter to transmit data over the serial bus without error. The list of calibrated signal strengths may be configured during manufacture or assembly of the mobile communication device. The list of calibrated signal strengths may be configured or modified during operation of the mobile communication device.

The processor-readable storage medium 1318 may include instructions that cause the processing circuit 1302 to receive a measurement of a reference signal representative of RF signal quality at the mobile communication device, determine whether the measurement of the reference signal indicates that the RF signal quality is less than a minimum RF signal quality level, and reduce signal strength of a transmitter coupled to a serial bus provided in the mobile communication device when the RF signal quality falls below the minimum RF signal quality level.

The processor-readable storage medium 1318 may include instructions that cause the processing circuit 1302 to determine that a transmission error occurred in a transmission over the serial bus, and increase the signal strength of the transmitter coupled to the serial bus in response to the transmission error. A list of calibrated signal strengths may be maintained by the mobile communication device. The processor-readable storage medium 1318 may include instructions that cause the processing circuit 1302 to remove an entry in the list of calibrated signal strengths when the transmission error occurs while the signal strength of the transmitter is defined by the entry in the list of calibrated signal strengths. The entry may be removed from the list of calibrated signal strengths after occurrence of a first transmission error or after repeated transmission errors have occurred while the signal strength of the transmitter is defined by the entry in the list of calibrated signal strengths.

In one example, the processor-readable storage medium 1318 includes instructions that cause the processing circuit 1302 to change the signal strength of the transmitter while the serial bus is idle, and calibrate timing of signals transmitted over the serial bus after changing the signal strength of the transmitter. The processor-readable storage medium 1318 may include instructions that cause the processing circuit 1302 to use a bus calibration procedure defined by C-PHY protocols or by D-PHY protocols when restarting the serial bus. The reference signal may be an RSRP signal transmitted in a 5G-NR wireless network.

The processor-readable storage medium 1318 may include instructions that cause the processing circuit 1302 to maintain a list of calibrated signal strengths at the mobile communication device. Each entry in the list of calibrated signal strengths indicates a signal strength level that has been verified as enabling the transmitter to transmit data over the serial bus without error. The list of calibrated signal strengths may be configured during manufacture or assembly of the mobile communication device. The list of calibrated signal strengths may be configured or modified during operation of the mobile communication device

Some implementation examples are described in the following numbered clauses:
1. A mobile communication device comprising: a wireless transceiver configured to transmit and receive radio frequency (RF) signals; a bus interface circuit coupled to a serial bus and configured for operation as a display serial interface (DSI); and a controller configured to: receive a measurement of a reference signal representative of RF signal quality at the mobile communication device; determine whether the measurement of the reference signal indicates that the RF signal quality is less than a minimum RF signal quality level; and reduce signal strength of a transmitter in the bus interface circuit when the RF signal quality falls below the minimum RF signal quality level.
2. The mobile communication device as described in clause 1, wherein the controller is further configured to: determine that a transmission error occurred in a transmission over the serial bus; and increase the signal strength of the transmitter in response to the transmission error.
3. The mobile communication device as described in clause 2, wherein a list of calibrated signal strengths is maintained by the mobile communication device, and wherein the controller is further configured to: remove an entry in the list of calibrated signal strengths when the transmission error occurs while the signal strength of the transmitter is defined by the entry in the list of calibrated signal strengths.
4. The mobile communication device as described in clause 3, wherein the entry is removed from the list of calibrated signal strengths after repeated transmission errors have occurred while the signal strength of the transmitter is defined by the entry in the list of calibrated signal strengths.
5. The mobile communication device as described in any of clauses 1-4, wherein the bus interface circuit is responsive to the controller and configured to: change the signal strength of the transmitter while the serial bus is idle; and calibrate timing of signals transmitted over the serial bus after changing the signal strength of the transmitter.
6. The mobile communication device as described in clause 5, wherein the bus interface circuit is further configured to: use a bus calibration procedure defined by C-PHY protocols when restarting the serial bus.
7. The mobile communication device as described in clause 5, wherein the bus interface circuit is further configured to: use a bus calibration procedure defined by D-PHY protocols when restarting the serial bus.
8. The mobile communication device as described in any of clauses 1-7, wherein the reference signal comprises a Reference Signal Received Power (RSRP) signal transmitted in a fifth-generation new radio (5G-NR) wireless network.
9. The mobile communication device as described in any of clauses 1-8, wherein the controller is further configured to: maintain a list of calibrated signal strengths at the mobile communication device, wherein each entry in the list of calibrated signal strengths indicates a signal strength level that has been verified as enabling the transmitter to transmit data over the serial bus without error.
10. The mobile communication device as described in clause 9, wherein the list of calibrated signal strengths is configured during manufacture or assembly of the mobile communication device.
11. A method for controlling radio frequency (RF) interference at a mobile communication device, comprising: receiving a measurement of a reference signal representative of RF signal quality at the mobile communication device; determining whether the measurement of the reference signal indicates that the RF signal quality is less than a minimum RF signal quality level; and reducing signal strength of a transmitter coupled to a serial bus provided in the mobile communication device when the RF signal quality falls below the minimum RF signal quality level, the serial bus configured to operate in accordance with a display serial interface (DSI) protocol.
12. The method as described in clause 11, further comprising: determining that a transmission error occurred in a transmission over the serial bus; and increasing the signal strength of the transmitter in response to the transmission error.
13. The method as described in clause 12, wherein a list of calibrated signal strengths is maintained by the mobile communication device, further comprising: removing an entry in the list of calibrated signal strengths when the transmission error occurs while the signal strength of the transmitter is defined by the entry in the list of calibrated signal strengths.
14. The method as described in clause 13, wherein the entry is removed from the list of calibrated signal strengths after repeated transmission errors have occurred while the signal strength of the transmitter is defined by the entry in the list of calibrated signal strengths.
15. The method as described in any of clauses 11-14, further comprising: changing the signal strength of the transmitter while the serial bus is idle; and calibrating timing of signals transmitted over the serial bus after changing the signal strength of the transmitter.
16. The method as described in clause 15, wherein calibrating timing of signals transmitted over the serial bus includes: using a bus calibration procedure defined by C-PHY protocols when restarting the serial bus.
17. The method as described in clause 15, wherein calibrating timing of signals transmitted over the serial bus includes: using a bus calibration procedure defined by D-PHY protocols when restarting the serial bus.
18. The method as described in any of clauses 11-17, wherein the reference signal comprises a Reference Signal Received Power (RSRP) signal transmitted in a fifth-generation new radio (5G-NR) wireless network.
19. The method as described in any of clauses 11-18, further comprising: maintaining a list of calibrated signal strengths at the mobile communication device, wherein each entry in the list of calibrated signal strengths indicates a signal strength level that has been verified as enabling the transmitter to transmit data over the serial bus without error.
20. The method as described in clause 19, wherein the list of calibrated signal strengths is configured during manufacture or assembly of the mobile communication device.
21. A processor-readable storage medium comprising code for: receiving a measurement of a reference signal representative of radio frequency (RF) signal quality at a mobile communication device; determining whether the measurement of the reference signal indicates that the RF signal quality is less than a minimum RF signal quality level; and reducing signal strength of a transmitter coupled to a serial bus provided in the mobile communication device when the RF signal quality falls below the minimum RF signal quality level, the serial bus configured to operate in accordance with a display serial interface (DSI) protocol.
22. The processor-readable storage medium as described in clause 21, further comprising code for: determining that a transmission error occurred in a transmission over the serial bus; and increasing the signal strength of the transmitter in response to the transmission error.
23. The processor-readable storage medium as described in clause 22, wherein a list of calibrated signal strengths is maintained by the mobile communication device, further comprising: removing an entry in the list of calibrated signal strengths when the transmission error occurs while the signal strength of the transmitter is defined by the entry in the list of calibrated signal strengths.
24. The processor-readable storage medium as described in clause 23, wherein the entry is removed from the list of calibrated signal strengths after repeated transmission errors have occurred while the signal strength of the transmitter is defined by the entry in the list of calibrated signal strengths.
25. The processor-readable storage medium as described in any of clauses 21-24, further comprising code for: changing the signal strength of the transmitter while the serial bus is idle; and calibrating timing of signals transmitted over the serial bus after changing the signal strength of the transmitter.
26. The processor-readable storage medium as described in clause 25, further comprising code for: using a bus calibration procedure defined by C-PHY protocols or by D-PHY protocols when restarting the serial bus.
27. The processor-readable storage medium as described in any of clauses 21-26, wherein the reference signal comprises a Reference Signal Received Power (RSRP) signal transmitted in a fifth-generation new radio (5G-NR) wireless network.
28. The processor-readable storage medium as described in any of clauses 21-27, further comprising code for: maintaining a list of calibrated signal strengths at the mobile communication device, wherein each entry in the list of calibrated signal strengths indicates a signal strength level that has been verified as enabling the transmitter to transmit data over the serial bus without error, and wherein the list of calibrated signal strengths is configured during manufacture or assembly of the mobile communication device.
29. A mobile communication apparatus, comprising: means for determining whether a measurement of a reference signal representative of radio frequency (RF) signal quality at the mobile communication apparatus indicates that the RF signal quality is less than a minimum RF signal quality level; and means for modifying signal strength of a transmitter coupled to a serial bus provided in the mobile communication apparatus, configured to reduce the signal strength of the transmitter when the RF signal quality falls below the minimum RF signal quality level, the serial bus configured to operate in accordance with a display serial interface (DSI) protocol.
30. The mobile communication apparatus as described in clause 29, further comprising: means for determining that a transmission error occurred in a transmission over the serial bus, wherein the means for modifying signal strength of a transmitter is further configured to increase the signal strength of the transmitter in response to the transmission error, wherein an entry in a list of calibrated signal strengths is deleted after repeated transmission errors have occurred while the signal strength of the transmitter is defined by the entry in the list of calibrated signal strengths.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A mobile communication device comprising:
a wireless transceiver configured to transmit and receive radio frequency (RF) signals;
a bus interface circuit coupled to a serial bus and configured for operation as a display serial interface (DSI); and
a controller configured to:
receive a measurement of a reference signal representative of RF signal quality at the mobile communication device;
determine whether the measurement of the reference signal indicates that the RF signal quality is less than a minimum RF signal quality level; and
reduce signal strength of a transmitter in the bus interface circuit when the RF signal quality falls below the minimum RF signal quality level.

2. The mobile communication device of claim 1, wherein the controller is further configured to:
determine that a transmission error occurred in a transmission over the serial bus; and
increase the signal strength of the transmitter in response to the transmission error.

3. The mobile communication device of claim 2, wherein a list of calibrated signal strengths is maintained by the mobile communication device, and wherein the controller is further configured to:
remove an entry in the list of calibrated signal strengths when the transmission error occurs while the signal strength of the transmitter is defined by the entry in the list of calibrated signal strengths.

4. The mobile communication device of claim 3, wherein the entry is removed from the list of calibrated signal strengths after repeated transmission errors have occurred while the signal strength of the transmitter is defined by the entry in the list of calibrated signal strengths.

5. The mobile communication device of claim 1, wherein the bus interface circuit is responsive to the controller and configured to:
change the signal strength of the transmitter while the serial bus is idle; and
calibrate timing of signals transmitted over the serial bus after changing the signal strength of the transmitter.

6. The mobile communication device of claim 5, wherein the bus interface circuit is further configured to:
use a bus calibration procedure defined by C-PHY protocols when restarting the serial bus.

7. The mobile communication device of claim 5, wherein the bus interface circuit is further configured to:
use a bus calibration procedure defined by D-PHY protocols when restarting the serial bus.

8. The mobile communication device of claim 1, wherein the reference signal comprises a Reference Signal Received Power (RSRP) signal transmitted in a fifth-generation new radio (5G-NR) wireless network.

9. The mobile communication device of claim 1, wherein the controller is further configured to:
maintain a list of calibrated signal strengths at the mobile communication device, wherein each entry in the list of calibrated signal strengths indicates a signal strength level that has been verified as enabling the transmitter to transmit data over the serial bus without error.

10. The mobile communication device of claim 9, wherein the list of calibrated signal strengths is configured during manufacture or assembly of the mobile communication device.

11. A method for controlling radio frequency (RF) interference at a mobile communication device, comprising:
receiving a measurement of a reference signal representative of RF signal quality at the mobile communication device;
determining whether the measurement of the reference signal indicates that the RF signal quality is less than a minimum RF signal quality level; and
reducing signal strength of a transmitter coupled to a serial bus provided in the mobile communication device when the RF signal quality falls below the minimum RF signal quality level, the serial bus configured to operate in accordance with a display serial interface (DSI) protocol.

12. The method of claim 11, further comprising:
determining that a transmission error occurred in a transmission over the serial bus; and
increasing the signal strength of the transmitter in response to the transmission error.

13. The method of claim 12, wherein a list of calibrated signal strengths is maintained by the mobile communication device, further comprising:
removing an entry in the list of calibrated signal strengths when the transmission error occurs while the signal strength of the transmitter is defined by the entry in the list of calibrated signal strengths.

14. The method of claim 13, wherein the entry is removed from the list of calibrated signal strengths after repeated transmission errors have occurred while the signal strength of the transmitter is defined by the entry in the list of calibrated signal strengths.

15. The method of claim 11, further comprising:
changing the signal strength of the transmitter while the serial bus is idle; and
calibrating timing of signals transmitted over the serial bus after changing the signal strength of the transmitter.

16. The method of claim 15, wherein calibrating the timing of signals transmitted over the serial bus includes:
using a bus calibration procedure defined by C-PHY protocols when restarting the serial bus.

17. The method of claim 15, wherein calibrating the timing of signals transmitted over the serial bus includes:
using a bus calibration procedure defined by D-PHY protocols when restarting the serial bus.

18. The method of claim 11, wherein the reference signal comprises a Reference Signal Received Power (RSRP) signal transmitted in a fifth-generation new radio (5G-NR) wireless network.

19. The method of claim 11, further comprising:
maintaining a list of calibrated signal strengths at the mobile communication device, wherein each entry in the list of calibrated signal strengths indicates a signal strength level that has been verified as enabling the transmitter to transmit data over the serial bus without error.

20. The method of claim 19, wherein the list of calibrated signal strengths is configured during manufacture or assembly of the mobile communication device.

21. A processor-readable storage medium comprising code for:
receiving a measurement of a reference signal representative of radio frequency (RF) signal quality at a mobile communication device;
determining whether the measurement of the reference signal indicates that the RF signal quality is less than a minimum RF signal quality level; and
reducing signal strength of a transmitter coupled to a serial bus provided in the mobile communication device when the RF signal quality falls below the minimum RF signal quality level, the serial bus configured to operate in accordance with a display serial interface (DSI) protocol.

22. The processor-readable storage medium of claim 21, further comprising code for:
determining that a transmission error occurred in a transmission over the serial bus; and
increasing the signal strength of the transmitter in response to the transmission error.

23. The processor-readable storage medium of claim 22, wherein a list of calibrated signal strengths is maintained by the mobile communication device, further comprising:
removing an entry in the list of calibrated signal strengths when the transmission error occurs while the signal strength of the transmitter is defined by the entry in the list of calibrated signal strengths.

24. The processor-readable storage medium of claim 23, wherein the entry is removed from the list of calibrated signal strengths after repeated transmission errors have occurred while the signal strength of the transmitter is defined by the entry in the list of calibrated signal strengths.

25. The processor-readable storage medium of claim 21, further comprising code for:
changing the signal strength of the transmitter while the serial bus is idle; and
calibrating timing of signals transmitted over the serial bus after changing the signal strength of the transmitter.

26. The processor-readable storage medium of claim 25, further comprising code for:
using a bus calibration procedure defined by C-PHY protocols or by D-PHY protocols when restarting the serial bus.

27. The processor-readable storage medium of claim 21, wherein the reference signal comprises a Reference Signal Received Power (RSRP) signal transmitted in a fifth-generation new radio (5G-NR) wireless network.

28. The processor-readable storage medium of claim 21, further comprising code for:
maintaining a list of calibrated signal strengths at the mobile communication device, wherein each entry in the list of calibrated signal strengths indicates a signal strength level that has been verified as enabling the transmitter to transmit data over the serial bus without error, and wherein the list of calibrated signal strengths is configured during manufacture or assembly of the mobile communication device.

29. A mobile communication apparatus, comprising:
means for determining whether a measurement of a reference signal representative of radio frequency (RF) signal quality at the mobile communication apparatus indicates that the RF signal quality is less than a minimum RF signal quality level; and
means for modifying signal strength of a transmitter coupled to a serial bus provided in the mobile communication apparatus, configured to reduce the signal strength of the transmitter when the RF signal quality falls below the minimum RF signal quality level, the serial bus configured to operate in accordance with a display serial interface (DSI) protocol.

30. The mobile communication apparatus of claim 29, further comprising:
means for determining that a transmission error occurred in a transmission over the serial bus, wherein the means for modifying signal strength of a transmitter is further configured to increase the signal strength of the transmitter in response to the transmission error,
wherein an entry in a list of calibrated signal strengths is deleted after repeated transmission errors have occurred while the signal strength of the transmitter is defined by the entry in the list of calibrated signal strengths.
